(19) United States
(12) Patent Application Publication
(10) Pub. No.: US 2019/0096383 A1
(43) Pub. Date: Mar. 28, 2019

(54) ACTIVE NOISE CONTROL ROOF PANEL DAMPENING SYSTEM

(71) Applicant: Panasonic Automotive Systems Company of America, Division of Panasonic Corporation of North America, Peachtree City, GA (US)

(72) Inventor: KARL CRESSMAN, FARMINGTON HILLS, MI (US)

(73) Assignee: Panasonic Automotive Systems Company of America, Division of Panasonic Corporation of North America

(21) Appl. No.: 16/139,310

(22) Filed: Sep. 24, 2018

Related U.S. Application Data
(60) Provisional application No. 62/561,863, filed on Sep. 22, 2017.

(51) Int. Cl. G10K 11/178; B62D 25/06

(52) U.S. Cl. CPC G10K 11/1781; B62D 25/06; G10K 2210/1282; G10K 2210/3211; G10K 2210/501; G10K 2210/121; G10K 2210/1291

(57) ABSTRACT

A noise dampening arrangement for a motor vehicle includes a mass coupled to a structural component of the motor vehicle. A sensor detects vibration of the structural component of the motor vehicle, and transmits a vibration signal indicative of the detected vibration. An electronic processor is communicatively coupled to the sensor, receives the vibration signal, and emits a vibration compensation signal dependent upon the vibration signal. An actuator is communicatively coupled to the electronic processor, receives the vibration compensation signal, and exerts a force on the mass dependent upon the vibration compensation signal such that the vibration of the structural component of the motor vehicle is reduced.

### CROSS-REFERENCE TO RELATED APPLICATION

This application claims benefit of U.S. Provisional Application No. 62/561,863 filed on Sep. 22, 2017, which the disclosure of which is hereby incorporated by reference in its entirety for all purposes.

### FIELD OF THE INVENTION

The disclosure relates to vibration dampening in a motor vehicle.

### BACKGROUND OF THE INVENTION

Vehicle light-weighting has reduced the ability of automakers to use mass as a dampening tool. Especially for vehicles with large areas of sheet metal (e.g., vans and sport utility vehicles with large roof areas or large sidewall panels), it is difficult to achieve enough stiffness to adequately prevent the sheet metal from vibrating. The resulting low-frequency energy is difficult to mitigate with any conventional technology. The end result is a vehicle that has poor noise, vibration and harshness (NVH) characteristics that creates customer dissatisfaction. In extreme cases, the customer is so dissatisfied that the vehicle must be bought-back by the manufacturer.

Current active noise cancellation (ANC) technology is not very useful below 50 Hz. A solution to the roof-generated booming requires a different type of approach, as the frequency requirements are typically in the 25-30 Hertz range, with a great deal of energy to mitigate. ANC simply does not have the capability to work effectively in the frequency range required.

Another conventional solution to this type of problem is to add a passive mass or additional dampening material. These solutions are at least partially effective, at a low cost. Adding mass is the enemy of fuel economy and may not address multiple resonance modes very well. Simple, mechanical approaches are limited to a single, narrow frequency range. Mechanical dampeners are also difficult to install consistently due to challenging ergonomics at the vehicle assembly plant.

### SUMMARY

The present invention may actively dampen vehicle roof vibration generated by engine firing orders. The dampening effect is achieved by observing the vehicle's panel motion with a sensor, calculating the inverse signal, and then exciting a mass 180 degrees out-of-phase to reduce the motion of the roof (or similar sheet metal panel). When the roof motion is treated this way, the noise problem becomes much smaller. No further mitigation may be required.

In another embodiment, accelerometers are mounted on the vehicle body and provide an input signal to a processor. The resulting “inverse signal” may be sent to a transducer and may act in opposition to the resonant behavior of the roof structure. Therefore, the usual “booming sounds” created by the reaction of the vehicle structure may be cancelled. In this implementation, road inputs (bumps in the road that affect the vehicle)—unrelated to engine firing order vibration—may be detected and mitigated in real time.

The invention may be similar to active noise control, where an inverse signal to the engine-driven noise is calculated, and a cancellation signal is output through a speaker. The inventive concept may include replacing the speaker (which works through the air) with a transducer which works directly through the vehicle's structure. The invention may reduce the noise at the source instead of responding to the downstream effect.

The invention may provide an active dampening system which can react to a vehicle's structural deficiencies over a wide frequency range by detecting the source vibration and countering the source vibration with an opposite-phase response.

In one embodiment, the invention comprises a noise dampening arrangement for a motor vehicle, including a mass coupled to a structural component of the motor vehicle. A sensor detects vibration of the structural component of the motor vehicle, and transmits a vibration signal indicative of the detected vibration. An electronic processor is communicatively coupled to the sensor, receives the vibration signal, and emits a vibration compensation signal dependent upon the vibration signal. An actuator is communicatively coupled to the electronic processor, receives the vibration compensation signal, and exerts a force on the mass dependent upon the vibration compensation signal such that the vibration of the structural component of the motor vehicle is reduced.

In another embodiment, the invention comprises a noise dampening method for a motor vehicle, including coupling a mass to a structural component of the motor vehicle. A vibration of the structural component of the motor vehicle is detected by a sensor placed in proximity to the targeted structure. A vibration signal indicative of the detected vibration is transmitted. A vibration compensation signal dependent upon the vibration signal is emitted. A force is exerted on the mass dependent upon the vibration compensation signal such that the vibration of the structural component of the motor vehicle is reduced.

In yet another embodiment, the invention comprises a noise dampening arrangement for a motor vehicle, including a mass dampener coupled to a structural component of the motor vehicle. The mass dampener outputs a mass dampener signal. A sensor detects vibration of the structural component of the motor vehicle, and transmits a vibration signal indicative of the detected vibration. A response calculation device is communicatively coupled to the sensor and to the mass dampener. The response calculation device receives at least one input signal indicative of the vibration signal and the mass dampener signal, and emits a vibration compensation signal dependent upon the input signal. An amplifier is communicatively coupled to the response calculation device and receives the vibration compensation signal. The amplifier amplifies the vibration compensation signal, and applies the amplified vibration compensation signal to the mass dampener such that the vibration of the structural component of the motor vehicle is reduced.

An advantage of the present invention is that controlling the structural resonance behavior directly is far more effective in mitigating the undesired noise than applying an acoustic treatment.

### BRIEF DESCRIPTION OF THE DRAWINGS

A better understanding of the present invention will be had upon reference to the following description in conjunction with the accompanying drawings.

FIG. 1 is a diagram of one example embodiment of an active noise control roof panel dampening arrangement of the present invention.

FIG. 2 is a schematic diagram of another example embodiment of an active noise control roof panel dampening arrangement of the present invention.

FIG. 3 is a flow chart of one embodiment of a noise dampening method of the present invention for a motor vehicle.

### DETAILED DESCRIPTION OF THE PREFERRED EMBODIMENTS

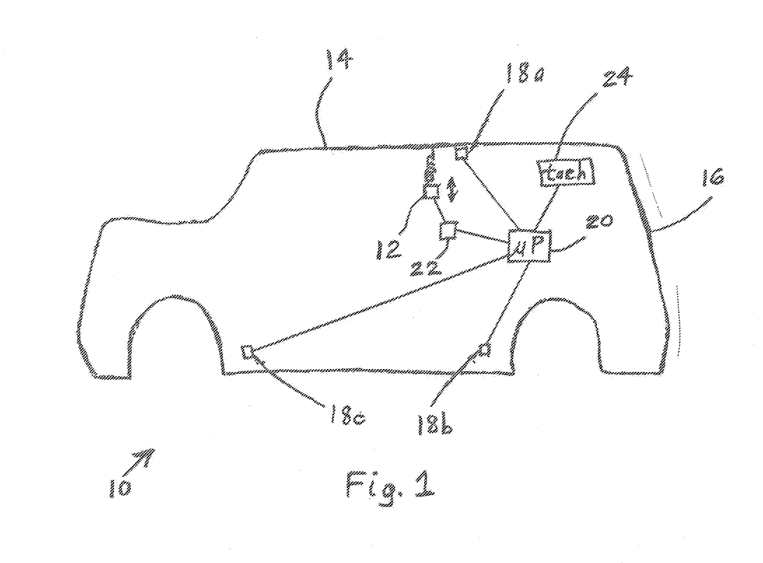

FIG. 1 illustrates one example embodiment of an active noise control roof panel dampening arrangement 10 of the present invention for a motor vehicle. Arrangement 10 includes a mass 12 coupled (mechanically, for example) to a roof 14 of vehicle 16. Arrangement 10 also includes accelerometers 18a-c spaced apart over a body or frame of vehicle 16. Accelerometers 18a-c may be communicatively coupled to an electronic processor 20, which, in turn, is communicatively coupled to an actuator 22. Actuator 22 may exert force on mass 12 and/or drive the movement of mass 12. In another embodiment, any one, any two or all three accelerometers 18a-c may be replaced by microphones.

During use, accelerometers 18a-c in conjunction with processor 20 may sense the frequency and/or amplitude of the vibration of roof 14 and/or other portions of the body, frame or chassis of vehicle 16. In response to this sensing, processor 20 may control actuator 22 to drive or excite mass 12 such that the motion of mass 12 is opposite in phase to the motion of roof 14, but possibly equal in frequency.

Because engine vibration may be the stimulus that causes vibration of roof 14, in one embodiment, processor 20 uses inputs from a vehicle engine tachometer 24 to control the movement of mass 12.

Accelerometers 18a-b, which are not attached to roof 14, may be used to nevertheless sense the vibration of roof 14, or may be used to sense the vibration of the parts of vehicle 16 that accelerometers 18a-b are attached to. Further, it is within the scope of the invention for a mass to be coupled to the parts of vehicle 16 that accelerometers 18a-b are attached to, and for such masses to be used to counteract the vibration of the parts of vehicle 16 that accelerometers 18a-b are attached to. Accordingly, the invention may also be applied to reduce the vibration of portions of the vehicle other than the roof.

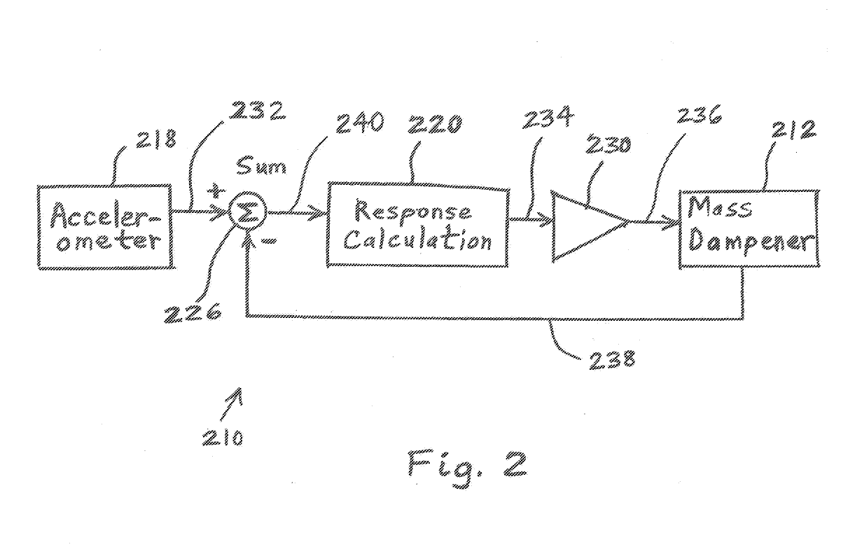

FIG. 2 illustrates another example embodiment of an active noise control roof panel dampening arrangement 210 of the present invention for a motor vehicle. Arrangement 210 includes an accelerometer 218, a summer 226, a response calculation device 220, an amplifier 230, and a mass dampener 212.

During use, accelerometer 218 senses the frequency and amplitude of vibration of a structural vehicle component, such as the roof, and emits a signal 232 indicative thereof. Response calculation device 220, such as an electronic processor, outputs a signal 234 having the same frequency as the vibration of the structural vehicle component, but opposite in phase. Amplifier 230 increases the magnitude of signal 234 to a level that may be dependent upon a sensed amplitude of the vibration of the structural vehicle component. A resulting output signal 236 of amplifier 230 is applied to mass dampener 212 in order to excite mass dampener 212 to vibrate at an amplitude, frequency and phase intended to cancel out and thereby cease the vibration of the structural vehicle component. If mass dampener 212 successfully stops the vibration of the structural vehicle component, then accelerometer signal 232 may no longer indicate any vibration, and signals 234, 236 may remain constant in order to continue the successful ceasing of the vibration. On the other hand, if accelerometer 218 continues to sense vibration, then a nonzero signal 232 may be added to the inverse of a mass dampener output signal 238 to produce a feedback signal 240 that may be received by response calculation device 220. Dependent upon feedback signal 240, response calculation device 220 may modify signal 234 to adjust the vibration of mass dampener 212. It then may again be determined whether the vibration of the structural component continues, and, if so, the above-described feedback process continues until there is no longer any vibration of the vehicle's structural component.

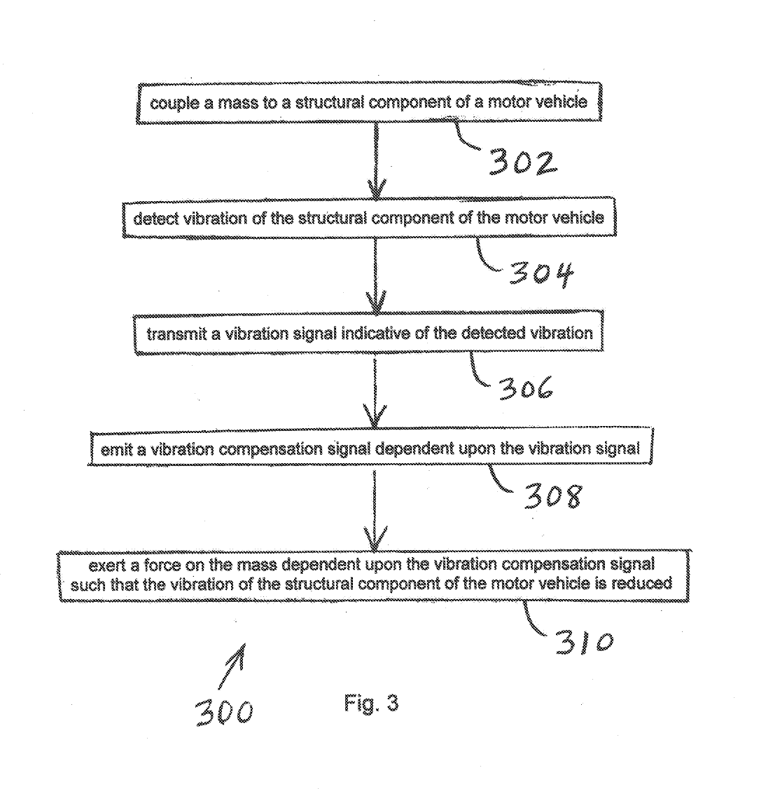

FIG. 3 illustrates one embodiment of a noise dampening method 300 of the present invention for a motor vehicle. In a first step 302, a mass is coupled to a structural component of the motor vehicle. For example, mass 12 may be mechanically coupled to a roof 14 of vehicle 16.

Next, in step 304, vibration of the structural component of the motor vehicle is detected. For example, accelerometers 18a-c in conjunction with processor 20 may sense the frequency and/or amplitude of the vibration of roof 14 and/or other portions of the body, frame or chassis of vehicle 16.

In a next step 306, a vibration signal indicative of the detected vibration is transmitted. For example, response calculation device 220, such as an electronic processor, outputs a signal 234 having the same frequency as the vibration of the structural vehicle component, but opposite in phase.

In step 308, a vibration compensation signal is emitted dependent upon the vibration signal. For example, output signal 236, dependent upon signal 234, is emitted by amplifier 230.

In a final step 310, a force is exerted on the mass dependent upon the vibration compensation signal such that the vibration of the structural component of the motor vehicle is reduced. For example, output signal 236 is applied to mass dampener 212 in order to excite mass dampener 212 to vibrate at an amplitude, frequency and phase intended to cancel out and thereby cease the vibration of the structural vehicle component.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A noise dampening arrangement for a motor vehicle, the arrangement comprising:
a mass coupled to a structural component of the motor vehicle;
a sensor configured to:
detect vibration of the structural component of the motor vehicle; and
transmit a vibration signal indicative of the detected vibration;
an electronic processor communicatively coupled to the sensor and configured to:
receive the vibration signal; and
emit a vibration compensation signal dependent upon the vibration signal; and
an actuator communicatively coupled to the electronic processor and configured to:
receive the vibration compensation signal; and
exert a force on the mass dependent upon the vibration compensation signal such that the vibration of the structural component of the motor vehicle is reduced.

2. The arrangement of claim 1 wherein the actuator is configured to exert a force on the mass dependent upon an amplitude of the vibration of the structural component of the motor vehicle.

3. The noise dampening arrangement of claim 1 wherein the structural component of the motor vehicle comprises a roof.

4. The noise dampening arrangement of claim 1 wherein the sensor comprises an accelerometer.

5. The noise dampening arrangement of claim 1 wherein the actuator is configured to amplify the vibration compensation signal.

6. The noise dampening arrangement of claim 1 wherein the sensor is configured to detect the frequency, amplitude and phase of the vibration of the structural component of the motor vehicle.

7. The noise dampening arrangement of claim 6 wherein the vibration compensation signal is 180 degrees out of phase with the vibration signal.

8. A noise dampening method for a motor vehicle, the method comprising:
coupling a mass to a structural component of the motor vehicle;
detecting vibration of the structural component of the motor vehicle;
transmitting a vibration signal indicative of the detected vibration;
emitting a vibration compensation signal dependent upon the, vibration signal; and
exerting a force on the mass dependent upon the vibration compensation signal such that the vibration of the structural component of the motor vehicle is reduced.

9. The method of claim 8 wherein the force is exerted on the mass dependent upon an amplitude of the vibration of the structural component of the motor vehicle.

10. The method of claim 8 wherein the structural component of the motor vehicle comprises a roof.

11. The method of claim 8 wherein the sensor comprises an accelerometer.

12. The method of claim 8 further comprising amplifying the vibration compensation signal, and wherein the force is exerted on the mass dependent upon the amplification of the vibration compensation signal

13. The method of claim 8 wherein the detecting step comprises detecting the frequency, amplitude and phase of the vibration of the structural component of the motor vehicle.

14. The method of claim 13 wherein the vibration compensation signal is 180 degrees out of phase with the vibration signal.

15. A noise dampening arrangement for a motor vehicle, the arrangement comprising:
a mass dampener coupled to a structural component of the motor vehicle and configured to output a mass dampener signal;
a sensor configured to:
detect vibration of the structural component of the motor vehicle; and
transmit a vibration signal indicative of the detected vibration;
a response calculation device communicatively coupled to the sensor and to the mass dampener, the response calculation device being configured to:
receive at least one input signal indicative of the vibration signal and the mass dampener signal; and
emit a vibration compensation signal dependent upon the input signal; and
an amplifier communicatively coupled to the response calculation device and configured to:
receive the vibration compensation signal;
amplify the vibration compensation signal; and
apply the amplified vibration compensation signal to the mass dampener such that the vibration of the structural component of the motor vehicle is reduced.

16. The noise dampening arrangement of claim 15 wherein the amplifier is configured to amplify the vibration compensation signal dependent upon an amplitude of the vibration of the structural component of the motor vehicle.

17. The noise dampening arrangement of claim 15 wherein the structural component of the motor vehicle comprises a roof.

18. The noise dampening arrangement of claim 15 wherein the sensor comprises an accelerometer.

19. The noise dampening arrangement of claim 15 wherein the at least one input signal comprises the mass dampener signal subtracted from the vibration signal.

20. The noise dampening arrangement of claim 15 wherein the sensor is configured to detect the frequency, amplitude and phase of the vibration of the structural component of the motor vehicle.
